(19) United States
(12) Patent Application Publication
(10) Pub. No.: US 2010/0091741 A1
(43) Pub. Date: Apr. 15, 2010

(54) WiFi system and method with high-speed mobile voice and video data communication

(75) Inventors: Michael Chen, Hsin-Chu (TW); Ming-Chen Chou, Hsin-Chu (TW); Sheng-Wang Hsieh, Taichung City (TW); Sue Yi-Shu Liu, Taipei City (TW)

Correspondence Address: BACON & THOMAS, PLLC, 625 SLATERS LANE, FOURTH FLOOR, ALEXANDRIA, VA, 22314-1176, US

(73) Assignee: Kuang Sheng Yun Ltd., Hsin-Chu (TW)

(21) Appl. No.: 12/379,491

(22) Filed: Feb. 24, 2009

(30) Foreign Application Priority Data
Oct. 13, 2008 (TW) 097139178

(51) Int. Cl. H04J 3/00

(52) U.S. Cl. 370/336

(57) ABSTRACT

A WiFi system with high-speed mobile voice and video data communication includes a plurality of mobile devices and a WiFi base station connected to a WiFi network. The WiFi base station transmits and receives packets to/from a mobile device within a time frame. The time frame is repeated at a predetermined period of time and divided into a plurality of variable-size time slots, each slot being assigned to a mobile device. The WiFi base station is based on an IEEE 802.11 standard to transmit/receive the packets respectively. Accordingly, all the WiFi base stations can use a single channel such that the handover between the WiFi base stations can be performed at high speed.

### BACKGROUND OF THE INVENTION

1. Field of the Invention

The present invention relates to the technical field of wireless data communication and, more particularly, to a WiFi system and method with high-speed mobile voice and video data communication.

2. Description of Related Art

Currently, many companies provide wireless voice and video data communication services. It is desired that a communication system such as a WiFi system can provide the cheap and easy-to-use voice and video communication services. However, the quality of voice and video data communication in current WiFi systems encounters many problems. For example, when a user is moving at high speed, the voice and multimedia video data has to be rapidly handed over from a WiFi base station to a next WiFi base station in real time. Otherwise, the data quality and system performance are reduced, and even the disconnection occurs.

To overcome this problem, a known solution is to use a single channel by all WiFi base stations to thereby perform a fast handover between the WiFi base stations. However, such a way results in system interference. Another solution is to use a hardware time-division multiplexing (TDM) to improve the system interference, as shown in FIG. 1 in which the multiplexers 2 are located between the base station 1 and the mobile phones T1, T2, T3 and applied to transfer the packets in the slots corresponding to the mobile phones T1, T2, T3 respectively. However, such a TDM technology cannot provide an efficient data handover at a high-speed movement in the WiFi system.

Therefore, it is desirable to provide an improved WiFi system and method with high-speed mobile voice and video data communication to mitigate and/or obviate the aforementioned problems.

### SUMMARY OF THE INVENTION

The object of the present invention is to provide a WiFi system with high-speed mobile voice and video data communication, which can avoid the interference and improve the quality of service (QoS) to thereby provide a low cost and high quality communication system.

In accordance with one aspect of the invention, there is provided a WiFi system with high-speed mobile voice and video data communication, which includes: a plurality of mobile devices; and at least one WiFi base station, which is based on an IEEE 802.11 standard to transmit and receive packets to/from a mobile device in a time frame which is repeated at a predetermined period of time and divided into a plurality of time slots corresponding to the mobile devices respectively. When transmitting predetermined packets from the WiFi base station to a mobile device, the WiFi base station prepares the predetermined packets only in corresponding slots assigned to the mobile device. When transmitting predetermined packets from the mobile device to the WiFi base station, the WiFi base station receives the predetermined packets in the corresponding slots assigned to the mobile device and sends an acknowledgement back to the mobile station, in which if the mobile device does not receive the acknowledgement, the mobile device waits for a back-off interval and retransmits the predetermined packets previously sent.

In accordance with another aspect of the invention, there is provided a method for performing high-speed mobile voice and video data communication in a WiFi system. The WiFi system includes a plurality of mobile devices and at least one WiFi base station which is based on an IEEE 802.11 standard to transmit and receive packets to/from a mobile device, wherein the WiFi base station prepares predetermined packets only in a corresponding slot assigned to the mobile device. The method includes: transmitting the predetermined packets in the corresponding slot assigned to the mobile device to the WiFi base station; sending an acknowledgement from the WiFi base station to the mobile device; and waiting for a back-off interval and retransmitting the predetermined packets previously sent by the mobile device if the mobile device does not receive the acknowledgement.

Accordingly, the method allows all the WiFi base stations to use a single channel such that the voice data and the multimedia video data can be rapidly handed over the WiFi base stations. Therefore, the interference is overcome and the QoS is improved.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a typical TDM technology;

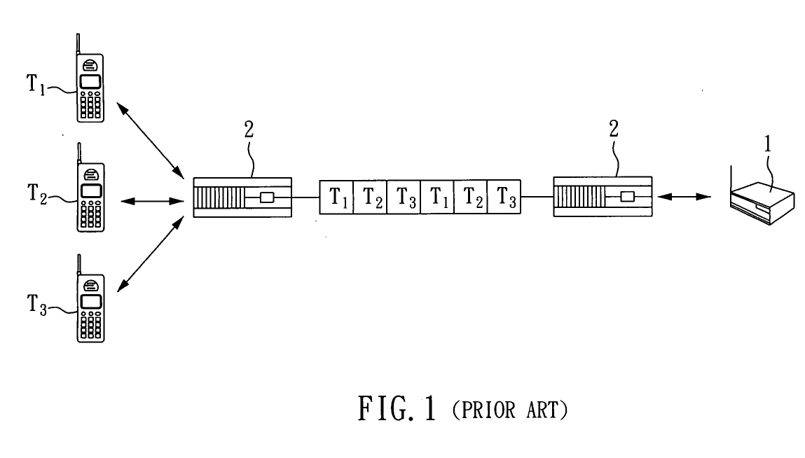

FIGS. 2(A)-(B) schematically illustrate a packet transmission operated in a WiFi system with high-speed mobile voice and video data communication according to an embodiment of the invention;

FIGS. 3(A)-(B) schematically illustrate a packet receiving operated in a WiFi system with high-speed mobile voice and video data communication according to an embodiment of the invention;

FIGS. 4(A)-(B) schematically illustrate a WiFi system with high-speed mobile voice and video data communication according to another embodiment of the invention; and

FIGS. 5(A)-(B) schematically illustrate a WiFi system with high-speed mobile voice and video data communication according to a further embodiment of the invention.

### DETAILED DESCRIPTION OF THE PREFERRED EMBODIMENT

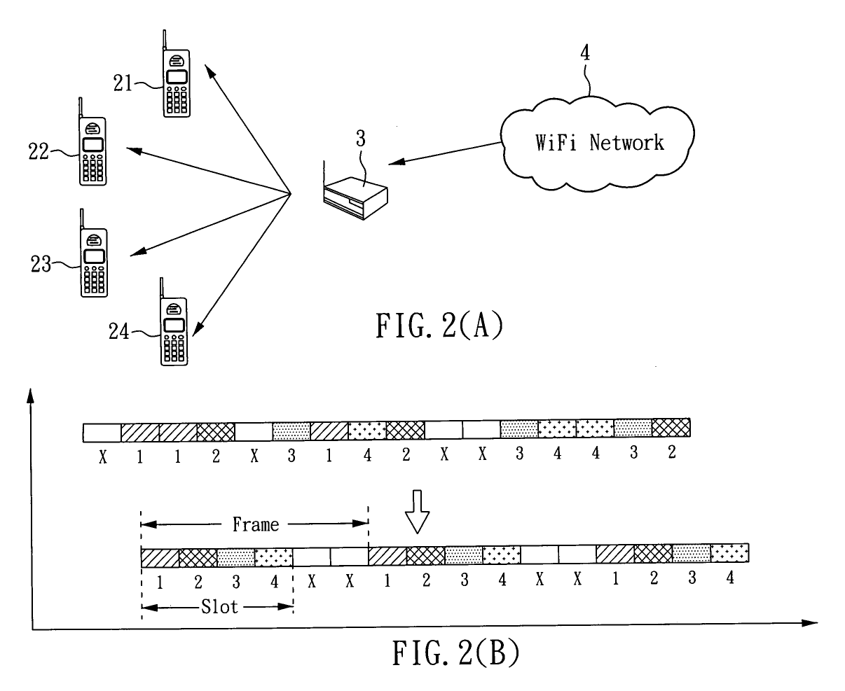

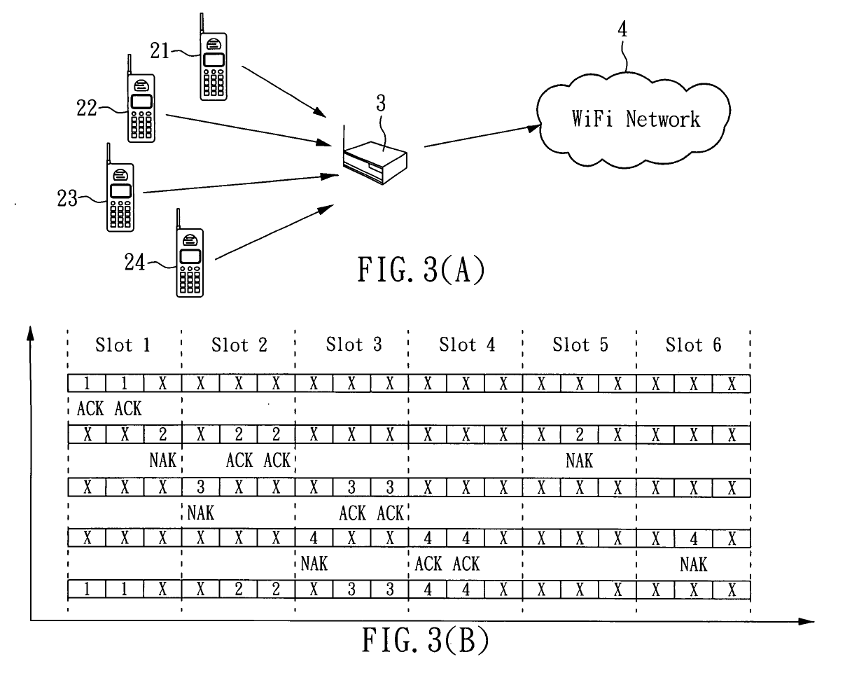

For better understanding, not for limit, a preferred embodiment of the invention is described below. FIGS. 2(A)-(B) schematically illustrate a WiFi base station 3 transmitting packets to mobile devices 21-24 according to an embodiment of the invention. FIGS. 3(A)-(B) schematically illustrate a WiFi base station 3 receiving packets from mobile devices 21-24 according to an embodiment of the invention. In FIGS. 2(A)-(B) and 3(A)-(B), four mobile devices 21, 22, 23, 24 and the WiFi base station 3 connected to a WiFi network 4 are included. As shown in FIGS. 2(A)-(B), the WiFi base station 3 receives the packets from the WiFi network 4 and sends the packets to the mobile stations 21, 22, 23, 24 in a time frame. Similarly, the WiFi base station 3 receives the packets from the mobile device 21, 22, 23, 24 in a time frame and sends them to the WiFi network 4.

The time frame is repeated at a predetermined period of time. The time frame is divided into a plurality of time slots, and the size of each time slot is changeable. Each slot corresponds to a mobile device. The WiFi base station 3 transmits/receives the packets through a transmission mechanism. The transmission mechanism is preferably an IEEE 802.11 standard. For ensuring that a slot is applied to a single mobile device, the packets of the slot sent by the other mobile devices are rejected by the WiFi base station 3. When packets are transmitted from the WiFi base station 3 to the mobile devices 21, 22, 23, 23, the WiFi base station 3 prepares predetermined packets at corresponding slots assigned to the mobile devices 21, 22, 23, 24. Namely, the WiFi base station 3 buffers the predetermined packets to be transmitted to the mobile devices 21, 22, 23, 24, and transmits the predetermined packets buffered to the mobile devices 21, 22, 23, 24 when all the corresponding slots assigned arrive. Accordingly, each slot is operated by the WiFi base station 3, as shown in FIGS. 2(A) and 2(B).

For transmitting predetermined packets from the mobile devices 21, 22, 23, 24 to the WiFi base station 3, the mobile devices 21, 22, 23, 24 are based on an IEEE 802.11 contention approach to transmit the predetermined packets to the WiFi base station 3. The IEEE 802.11 standard defines an acknowledgment (ACK) mechanism to push away the packets, which are not allowed to be transmitted, of the mobile devices 21, 22, 23, 24 in a slot. The WiFi base station 3 does not send an acknowledgment (NAK) for the packets which are not corresponding to a specific slot, and the mobile devices 21, 22, 23, 24 that transmit the packets wait for a back-off interval and the retransmit the packets previously sent. When the packets transmitted in the specific slot are sent by the corresponding or desired mobile devices 21, 22, 23, 24, the WiFi base station 3 sends an acknowledgment (ACK) to achieve the IEEE 802.11 mechanism. Namely, when the packets in the slots respectively corresponding to the mobile devices are transmitted to the WiFi base station 3, the WiFi base station 3 immediately generates and sends an acknowledgement to the mobile devices 21, 22, 23, 24. The acknowledgement is preferably defined by the IEEE 802.11 standard. If there is no acknowledgement received, the mobile devices 21, 22, 23, 24 wait for a back-off interval and retransmit the packets previously sent, until all the packets are successfully transmitted, as shown in FIGS. 3(A) and 3(B). Such a mechanism allows the mobile devices to have the respective slots to thereby reduce the bandwidth waste due to collision, increase the transmission efficiency, and obtain the qualified multimedia service. Thus, all the WiFi base stations can use a single channel, and the voice and video data can be rapidly handed over the WiFi base stations.

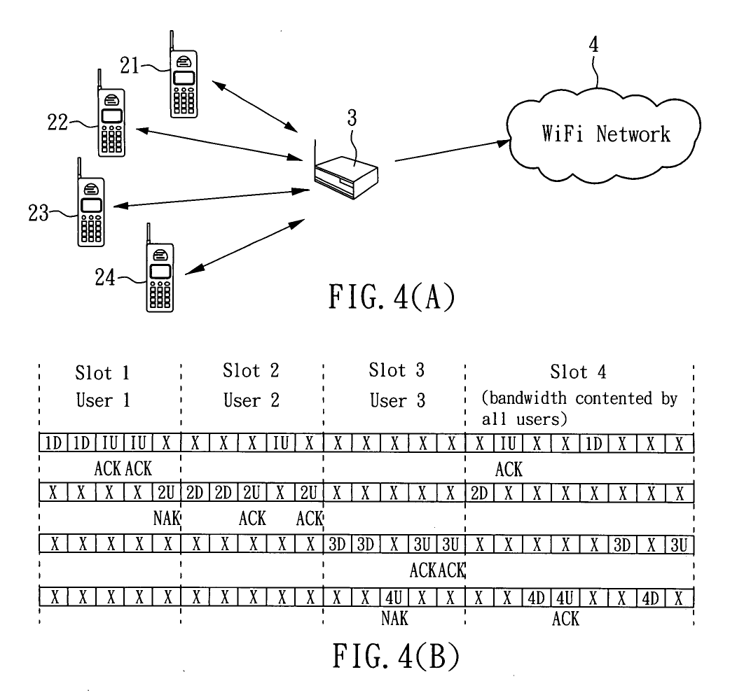

FIGS. 4(A)-(B) schematically illustrate a WiFi system with high-speed mobile voice and video data communication according to another embodiment of the invention. As shown in FIGS. 4(A)-(B), the WiFi system includes four mobile devices 21, 22, 23, 24 and a WiFi base station 3 connected to a WiFi network 4. The WiFi base station 3 is based on the IEEE 802.11 standard to transmit and receive packets to/from the mobile devices 21, 22, 23, 24. The WiFi base station 3 prepares predetermined packets only at corresponding slots assigned to the mobile devices. The corresponding slots are of variable-size. First, the predetermined packets are transmitted to the WiFi base station 3 in the corresponding slots assigned to the mobile devices 21, 22, 23, 24, and the WiFi base station 3 sends an acknowledgement back to the mobile devices 21, 22, 23, 24. The acknowledgement is defined by the IEEE 802.11 standard. If the mobile devices 21, 22, 23, 24 do not receive the acknowledgement, the mobile devices 21, 22, 23, 24 wait for a back-off interval and retransmit the packets previously sent, until all the packets are successfully transmitted. The WiFi base station 3 transmits predetermined packets in the corresponding slots to the mobile devices 21, 22, 23, 24. As shown in FIG. 4(B), this embodiment assigns Slot 1, Slot 2, Slot 3 to the mobile devices 21, 22, 23 respectively, and also Slot 4 is used by the mobile devices 21, 22, 23, 24 based on the IEEE 802.11 contention mechanism.

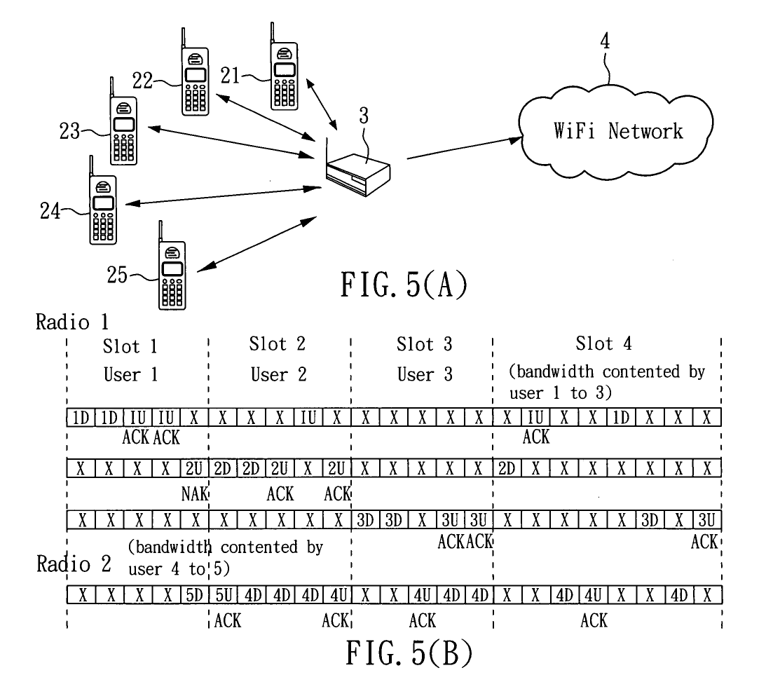

FIGS. 5(A)-(B) schematically illustrates a WiFi system with high-speed mobile voice and video data communication according to a further embodiment of the invention. As shown in FIGS. 5(A)-(B), the WiFi system includes five mobile devices 21, 22, 23, 24, 25 and a WiFi base station 3 connected to a WiFi network 4. The WiFi base station 3 is based on the IEEE 802.11 standard to transmit and receive packets to/from the mobile devices 21, 22, 23, 24, 25. The WiFi base station 3 can operate at different radio frequencies. In this embodiment, first and second radio frequencies are given as an example for description. At the first radio frequency, the operation is identical to the embodiment of FIGS. 4(A) and 4(B). In this case, the WiFi base station 3 prepares the predetermined packets only at corresponding slots assigned to the mobile devices 21, 22, 23, 24. The corresponding slots are of variable-size. When the WiFi base station 3 is based on the IEEE 802.11 standard to receive the packets from the mobile devices 21, 22, 23, 24, the predetermined packets at the corresponding slots assigned to the mobile devices 21, 22, 23, 24 are transmitted to the WiFi base station 3, and accordingly the WiFi base station 3 sends an acknowledgement back to the mobile devices 21, 22, 23, 24. The acknowledgement is defined by the IEEE 802.11 standard. If the mobile devices 21, 22, 23, 24 do not receive the acknowledgement, the mobile devices 21, 22, 23, 24 wait for a back-off interval and retransmit the predetermined packets previously sent, until all the predetermined packets are successfully transmitted. The WiFi base station 3 transmits the predetermined packets in the corresponding slots to the mobile devices 21, 22, 23, 24, and Slot 1, Slot 2, Slot 3 are assigned respectively to the mobile devices 21, 22, 23 while Slot 4 is used by the mobile devices 21, 22, 23, 24 based on the IEEE 802.11 contention approach. At the second radio frequency, all slots are defined to be used by the mobile device 24, 25 based on the IEEE 802.11 contention mechanism.

In view of the foregoing, it is known that the invention is able to allow all WiFi base stations to use a single channel to thereby rapidly hand over the voice and video data between the WiFi base stations. Therefore, the interference problem is overcome and the QoS is improved.

Although the present invention has been explained in relation to its preferred embodiment, it is to be understood that many other possible modifications and variations can be made without departing from the spirit and scope of the invention as hereinafter claimed.

What is claimed is:

1. A WiFi system with high speed mobile voice and video data communication, comprising:
a plurality of mobile devices; and
at least one WiFi base station, which is based on an IEEE 802.11 standard to transmit and receive packets to/from a mobile device in a time frame which is repeated at a predetermined period of time and divided into a plurality of time slots corresponding to the mobile devices respectively;
wherein, when transmitting predetermined packets from the WiFi base station to a mobile device, the WiFi base station prepares the predetermined packets only in corresponding slots assigned to the mobile device; when transmitting predetermined packets from the mobile device to the WiFi base station, the WiFi base station receives the predetermined packets in the corresponding slots assigned to the mobile device and sends an acknowledgement back to the mobile station, in which if the mobile device does not receive the acknowledgement, the mobile device waits for a back-off interval and retransmits the predetermined packets previously sent.

2. The system as claimed in claim 1, wherein the WiFi base station buffers the predetermined packets before the predetermined packets are prepared in the corresponding slot.

3. The system as claimed in claim 1, wherein the corresponding slot is of variable-size.

4. The system as claimed in claim 1, wherein the acknowledgement is defined by the IEEE 802.11 standard.

5. The system as claimed in claim 1, wherein the WiFi base station is connected to a WiFi network.

6. The system as claimed in claim 1, wherein one of the plurality of slots is defined to be used by the mobile device based on an IEEE 802.11 contention approach.

7. A method for performing high speed mobile voice and video data communication in a WiFi system including a plurality of mobile devices and at least one WiFi base station which is based on an IEEE 802.11 standard to transmit and receive packets to/from a mobile device, wherein the WiFi base station prepares predetermined packets only in a corresponding slot assigned to the mobile device, the method comprising:
transmitting the predetermined packets in the corresponding slot assigned to the mobile device to the WiFi base station; and
sending an acknowledgement from the WiFi base station to the mobile device.

8. The method as claimed in claim 7, wherein the acknowledgement is defined by the IEEE 802.11 standard.

9. The method as claimed in claim 7, wherein the corresponding slot is of variable-size.

10. The method as claimed in claim 7, wherein the WiFi base station is connected to a WiFi network.
